(19) United States
(12) Patent Application Publication
(10) Pub. No.: US 2010/0216587 A1
(43) Pub. Date: Aug. 26, 2010

(54) ARRANGEMENT FOR TRANSMITTING A TORQUE FROM A TRANSMISSION TO SIDESHAFT

(75) Inventors: Joachim Horst, Overath (DE); Wolfgang Hidebrandt, Siegburg (DE); Gert Herrmann, Solingen (DE); Heiko Kossack, Koehn (DE)

Correspondence Address: GKN Driveline/TTG, c/o Kristin L. Murphy, 39533 Woodward Avenue, suite 140, Bloomfield Hills, MI, 48304, US

(73) Assignee: GKN DRIVELINE INTERNATIONAL GMBH, Lohmar (DE)

(21) Appl. No.: 12/674,569

(22) PCT Filed: Jul. 16, 2008
(86) PCT No.: PCT/EP2008/059315

§ 371 Date: Mar. 23, 2010

(30) Foreign Application Priority Data
Aug. 20, 2007 (DE) 10 2007 039 336.0

(51) Int. Cl. F16H 37/02

(52) U.S. Cl. 475/207

(57) ABSTRACT

An arrangement for transmitting a torque from a transmission of a motor vehicle to a sideshaft is disclosed. The arrangement comprises a transmission having a transmission housing and a sideshaft assembly. The sideshaft assembly has at least one differential with a differential housing, a hollow shaft, a first sideshaft and a second sideshaft. The sideshaft assembly extends through the transmission housing and the differential being arranged outside the transmission housing.

### TECHNICAL FIELD

The present disclosure relates to an arrangement for transmitting a torque to sideshafts in a motor vehicle and to a joint outer body of a constant velocity joint for use in an arrangement.

### BACKGROUND

Solutions for transmitting torque for front axles of front wheel drive vehicles are known from the prior art. Such solutions have a differential integrated into the transmission and intermediate shafts. To connect the transmission to those wheels of the motor vehicle which are fastened to the sideshafts, the intermediate shafts are connected via a flange connection or a plug-in connection, firstly to the lateral gears of the differential, and secondly to the joint outer bodies of constant velocity joints.

As a consequence of the arrangement of the differential in the transmission, adapting diverse components, in particular, the intermediate shaft and the differential, to lower or higher torques is possible only if the transmission is additionally adapted. Accordingly, the design of the components is oriented toward the transmission of higher torques, the result of which is a greater weight for the overall arrangement and uneconomical material application.

Furthermore, in most cases, the differential is arranged in the lower region of the transmission and therefore moves in the transmission oil sump. This arrangement leads to churning losses and an overall poorer degree of efficiency in comparison with an arrangement whereby the differential is arranged outside the transmission body.

In addition, in the case of transversely mounted engines, in which the differential does not usually coincide with the central vehicle longitudinal axis, equally long intermediate shafts between the differential and the constant velocity joint or equally long sideshafts between the constant velocity joint and the wheel cannot be realized. The result of this deficiency is that the torsional spring rigidity of the shaft arrangement is not identical for each wheel of the motor vehicle. A different response behavior of the driven wheels can therefore occur, in particular in the case of high acceleration values of the vehicle.

Therefore there exists a need to solve, at least partially, the problems which are described in the prior art and, in particular, to provide an arrangement that allows for a more flexible adaptation of the individual components to the technical boundary conditions, permits a higher degree of energy efficiency and restricts the part diversity, and, furthermore, to provide a joint outer body which can be used in the arrangement.

### SUMMARY

An arrangement for transmitting a torque from a transmission of a motor vehicle to a sideshaft is disclosed, the arrangement comprising at least:
one transmission having at least one transmission housing, and
one sideshaft assembly having at least one differential with a differential housing, a hollow shaft, a first sideshaft and a second sideshaft,
wherein the sideshaft assembly extends partially through the transmission housing and the differential is arranged outside the transmission housing.

Here, an arrangement is described, in particular, which is suitable for use in front axles in the case of front wheel drive motor vehicles, in which a transmission transmits the torques via a differential to the sideshafts of the front wheels of the motor vehicle.

An exemplary arrangement will be described with an open (nonlocked) differential in the following text. The exemplary arrangement has, in particular, two planetary bevel gears that rotate with the differential housing about a central rotational axis of the sideshaft assembly, and two bevel gears which are in engagement with the planetary gears and are arranged on the central rotational axis. Here, one (second) bevel gear is connected to an intermediate shaft, which extends through a hollow shaft to a second joint outer body, and therefore transmits the transmission torques via the intermediate shaft and a second joint outer body to the second sideshaft. The other (first) bevel gear forms a structural unit with a first joint outer body and therefore transmits the transmission torques to the first sideshaft.

As an alternative, however, any differential which is known from the prior art can be used. In particular, the transmission of torque from the differential housing via intermediate gearwheels (worm gearwheels, bevel gearwheels, helical gearwheels, etc.) to further gearwheels, which are arranged on output shafts, can be of different design. What is continuously significant here for the application is only the transfer of the torque from the differential housing to two shafts (an intermediate shaft and a first joint outer body here) via gearwheels which are arranged in the differential. For example, multiple disk locking differentials, electronically controlled differentials, locking differentials with a friction cone, locking differentials with helical gearwheels, locking differentials with worm gearwheels, locking differentials with a viscous coupling, and also locking differentials without toothing can be used.

The sideshaft assembly comprises, in one particular arrangement, a common central rotational axis for the joint outer bodies which are connected to one another via the differential, inter alia. The sideshaft assembly then penetrates a part of the transmission housing. The result of this arrangement is that the sideshafts of the sideshaft assembly extend toward the wheels on both sides of the transmission. The differential of the sideshaft assembly is additionally arranged outside the transmission housing, that is to say, in other words, between the transmission and the wheel and/or the constant velocity joint. The problems which were mentioned in the background can therefore be overcome, as will also be explained in the following text in relation to the further design variants and the figures.

To decouple the vehicle and the drive unit (engine, etc.), inter alia, also from the transmission and the differential, from the translatory wheel movements, the torques of the drive unit are transmitted via constant velocity joints to the sideshafts and therefore to the wheels. Here, the constant velocity joints can be configured as plunge joints or fixed joints.

According to one development of the arrangement disclosed herein, the arrangement includes the first sideshaft having a first joint with a first joint outer body and the second sideshaft having a second joint with a second joint outer body, and the first sideshaft being connected to the differential via the first joint and the second sideshaft being connected to the differential via the second joint. The joints which are mentioned here and connect the two sideshafts can, in principle, be configured according to the known design for motor vehicles or comparably driven vehicles, similar or even identical designs being proposed for both joints of a sideshaft assembly, in particular. For example, what are known as plunge joints are preferred which reliably ensure a transmission of torque even in the case of deflected shafts and an axial relative movement of the shafts with respect to one another.

It is proposed, according to another alternative arrangement, that the first joint outer body is integrated at least partially into the differential. A movement of the joint outer body within the differential occurs as a consequence of different movements of the drive wheels of the motor vehicle (for example, when driving around bends). The joint outer body is therefore arranged in the differential housing such that it can be rotated with respect to the differential and is sealed with respect to the surroundings via sealing elements between the differential housing and the joint outer body.

In particular, the joint outer body is mounted within the differential in such a way that any forces which act on the joint outer body via the sideshaft are dissipated via the differential housing, and/or via the sideshaft assembly and the transmission housing. According to a further refinement, the joint outer body can also be mounted outside the differential housing, with the result that any forces of the sideshafts via the joint outer body are dissipated not via the differential, but rather via bearings outside the differential housing, for example to the body of the vehicle.

According to a further expedient embodiment, the differential housing is in engagement with the hollow shaft, and the hollow shaft transmits a torque of the transmission via drive means of the hollow shaft and via output means of the transmission. Here, the drive means and output means can be configured as gearwheels, belts or disks which are connected to one another nonpositively, in particular. Here, the hollow shaft is connected fixedly to the differential housing and is mounted in the transmission housing.

According to a further advantageous embodiment, the drive means of the hollow shaft is a main drive gearwheel and the output means of the transmission is an output gearwheel, and the main drive gearwheel is in engagement with the output gearwheel. Here, the main drive gearwheel of the hollow shaft or the sideshaft assembly is connected to the hollow shaft, with the result that torques can be transmitted via the transmission to the drive gearwheel and/or to the differential outer body.

Furthermore, the hollow shaft serves to make it possible for the second joint to be connected via a coupler shaft to the differential and/or the bevel gear in the differential, the coupler shaft being guided through the hollow shaft and being supported in the latter. The coupler shaft also serves to make it unnecessary for different spacings between the differential and the wheels to be compensated for by different sideshaft lengths, with the result that a symmetrical arrangement of the joint outer bodies with respect to the respective wheels is possible. The coupler shaft makes it possible to provide an arrangement which makes it possible to equalize the torsional spring rigidity of the components for the transmission of the torques to the wheels of the motor vehicle in such a way that the driven wheels exhibit a very uniform response behavior, in particular in the case of pronounced load changes.

According to a further refinement, the differential housing has at least one supporting face for at least one bevel gear which is connected to the joint outer body. Here, the supporting face serves to fix the bevel gear and/or the joint outer body within the differential housing, with the result being that firstly, the joint outer body is arranged rotatably in the differential housing and secondly, it is impossible for the joint outer body to fall out of the differential housing. The bevel gear has a face which lies opposite the supporting face and is configured so as to correspond. The bevel gear is preferably attached on a shoulder or on the circumference of the joint outer body and is advantageously shaped as a bevel gear disk which is mounted on the outside (so as to lie opposite the joint ball tracks) and can thus interact with a planetary gear of the differential which is likewise of beveled configuration here.

According to a further refinement, the transmission has a first lubricating system and the differential has a second lubricating system, the first lubricating system and the second lubricating system being configured independently of one another. In other words, this means, in particular, that the lubricants of both components are not mixed (directly). In principle, in particular, separate lubricants, lubricant reservoirs, lubricant feed lines and discharge lines or the like can be provided. Firstly, a reduction in the churn losses and therefore an improvement in the degree of efficiency of the drive unit occur as a result of the arrangement of the differential outside the first lubricating system of the transmission. Secondly, the lubrication of the differential can be adapted in a particularly satisfactory manner to the requirements of said assembly. In particular, grease lubrication can therefore also be realized in the second lubricating system.

According to a further advantageous refinement, the differential and at least the first joint form a common second lubricating system. This feature leads to a further cost advantage of the compact arrangement of the differential and the first joint. In this refinement, the first joint outer body can have at least one aperture to the differential housing, thus to make common lubrication possible with the same lubricant firstly of the first joint and secondly of the differential.

As a result of the arrangement of the differential outside the transmission, they can be combined with one another independently of one another for a very wide variety of applications or loads. Here, in particular, the transmissions can be designed independently of the respective differential type or the overall size.

A joint outer body, to which the disclosure relates, can, in principle, be used in the arrangement according to the disclosure and is distinguished by the fact that the joint outer body has a bevel gear. Here, the joint outer body on the opposite side from the receptacle of the sideshaft has on the outside an integrated (for example, machined) and/or separate (and fastened on the outside) bevel gear. Here, the bevel gear can be produced, in particular, together with the joint outer body and can accordingly have the same material. However, it can also be connected to the latter by different joining techniques and can accordingly comprise different materials, with the result that the bevel gear can be designed specifically for the application. Finally, the bevel gear is driven as a consequence of the rotation of the differential body by the planetary gears which are fastened in the differential body, with the result that torques are transmitted via the transmission and the differential body to the joint outer body and therefore to the sideshaft.

It is to be noted for the sake of completeness that, in special cases (as an alternative or cumulatively), identically acting transmission elements can be provided on the outside of the joint outer body, in particular other gearwheel types, wedge shaped toothing systems, positively locking elements, etc. These are preferably configured as a separate component and are connected to the joint outer body; however, this is not necessary, with the result that optionally a single piece variant can exist.

According to a further development, the bevel gear is connected releasably to the joint outer body. A replacement or a repair of the differential is therefore likewise possible optionally—the joint outer bodies can therefore likewise be integrated later into other differentials, after the correspondingly required gearwheel has been mounted again.

Additionally, the disclosure may particularly relate to a motor vehicle having at least one arrangement according to the disclosure for the transmission of torque from an engine via the transmission and the sideshafts toward the wheels.

### BRIEF DESCRIPTION OF THE DRAWINGS

The disclosure and the technical background will be explained in the following text using the figures. Reference is made to the fact that the figures show particular exemplary design variants, to which said invention is not restricted, however. In the figures, in a diagrammatic manner:

FIG. 1 shows a cross section through a first design variant of the arrangement,

FIG. 2 shows a cross section through a further exemplary embodiment of a transmission having a sideshaft assembly, and

FIG. 3 shows a cross section through a differential having an integrated joint.

### DETAILED DESCRIPTION

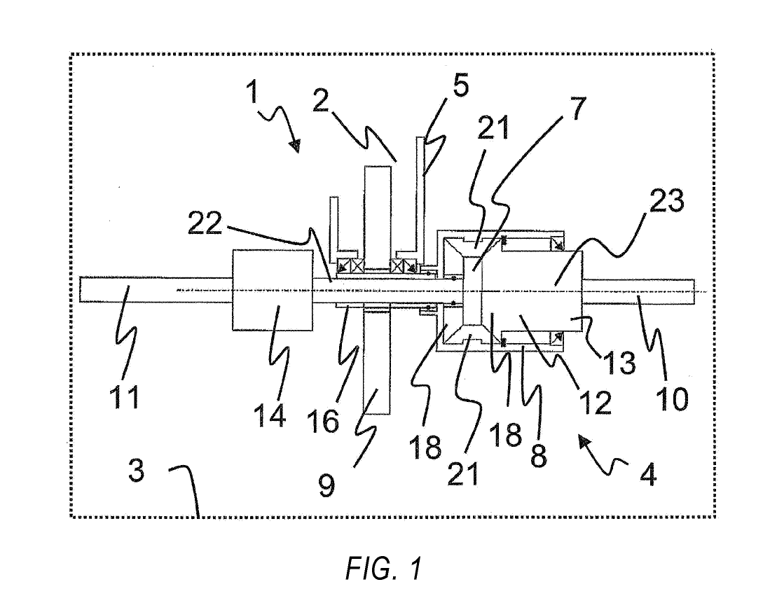

FIG. 1 diagrammatically shows, as a constituent part of a motor vehicle 3, a cross section of an arrangement 1 comprising a sideshaft assembly 4 and a transmission 2 which is delimited by a transmission housing 5. The sideshaft assembly 4 is mounted in the transmission housing 5 and is sealed with respect to the transmission 2. The sideshaft assembly 4 is driven via drive means, in the present exemplary embodiment by a main drive gearwheel 9 which is arranged in the transmission housing 5. The main drive gearwheel 9 transmits a torque of the transmission 2 via a hollow shaft 16 of the sideshaft assembly 4 to the differential housing 8 of a differential 7, which differential housing 8 is connected to the hollow shaft 16.

The differential 7 is configured as a bevel gear differential in this exemplary embodiment. Planetary gears 21 are arranged in a rotatably mounted manner in the differential housing 8, which planetary gears 21 drive the bevel gears 18 (other gearwheels can be used depending on the differential type) in the same direction and at the same speed as a consequence of a rotation of the differential housing 8. In the event of a different rotational movement of the first sideshaft 10 and the second sideshaft 11, for example as a result of the motor vehicle 3 driving around a bend, the planetary gears 21 compensate for the differential movement between the first sideshaft 10 and the second sideshaft 11 and the bevel gears 18.

Furthermore, a first joint 12 having a first joint outer body 13 is arranged within the differential 7, the first joint 12 being configured as a plunge joint and receiving the sideshaft 10 within itself The torques which are transmitted from the transmission 2 via the main drive gearwheel 9 and the hollow shaft 16 to the differential outer housing 8 are forwarded via the bevel gears 18 firstly to the first joint outer body 13 and secondly to a coupler shaft 22 which is guided through the hollow shaft 16 and is connected to a second joint 14 which, as a plunge joint, receives the second sideshaft 11 in an articulated manner.

Accordingly, the sideshaft assembly 4 forms a common rotational axis 23 for the first sideshaft 10, the second sideshaft 11, the first joint 12, the second joint 14 and the planetary gears 21 of the differential 7.

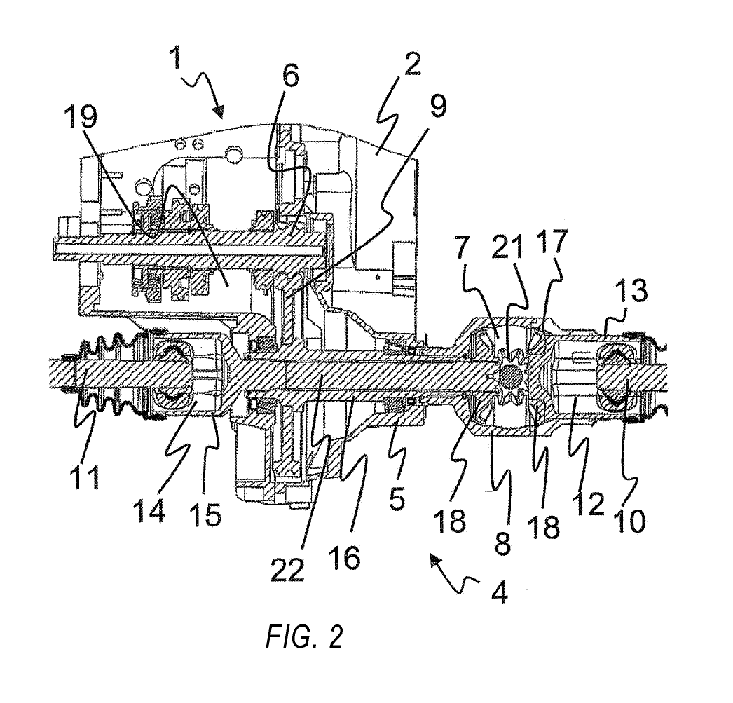

FIG. 2 shows a cross section through a transmission 2 and a side-shaft assembly 4 of the arrangement 1, an output means, here an output gearwheel 6, being arranged within the transmission 2 in such a way that it is in engagement with a drive means, here a main drive gearwheel 9, of the sideshaft assembly 4. Here, the main drive gearwheel 9 is received within the transmission housing 5, the main drive gearwheel 9 transmitting torque of the output gearwheel 6 via the hollow shaft 16 to the differential housing 8, the hollow shaft 16 being mounted in the transmission housing 5. Here, the transmission 2 has a first lubricating system 19 which is separate from the differential (likewise described as a bevel gear differential here), only the drive gearwheel 9 of the sideshaft assembly 4 being moved in the lubricating sump of the transmission 2.

Two bevel gears 18, which lie opposite one another, and two planetary gears 21, which lie opposite one another, are arranged within the differential 7, and furthermore a first joint 12 having a first joint outer body 13. The first sideshaft 10 is received in an articulated manner within the first joint 12 which is configured here as a plunge joint, the supporting face 17 serving firstly to mount and fix the bevel gear 18 and/or the first joint outer body 13 within the differential housing 8 and it being possible secondly to use said supporting face 17 as a friction cone for use as a locking differential. The bevel gears 18, which are driven via the differential housing 8 and via the planetary gears 21, drive firstly the first joint outer body 13 and secondly the coupler shaft 22, which for its part is connected directly or indirectly to the second joint outer body 15. In particular, in the case of an indirect connection of the coupler shaft 22 and the second joint outer body 15, for example by a corresponding wedge-shaped toothing system and plug in connection, the coupler shaft 22 is to be mounted rotatably in the hollow shaft 16 in such a way that an undesired excitation of the arrangement is avoided which is familiar to a person skilled in the art as “humming”. At the same time, asymmetrical elements of the transmission arrangement can be compensated for via the coupler shaft 22, which asymmetrical elements would have to be used as a consequence of the first sideshafts 10 and second sideshafts 11 of different size of said transmission arrangement, with the result that different torsional spring rigidities of the drive components would be the consequence.

The second sideshaft 11 is received in an articulated manner in the second joint 14 which is configured as a plunge joint, with the result that translatory movements of the wheels of the motor vehicle 3 can be absorbed by the second joint 14.

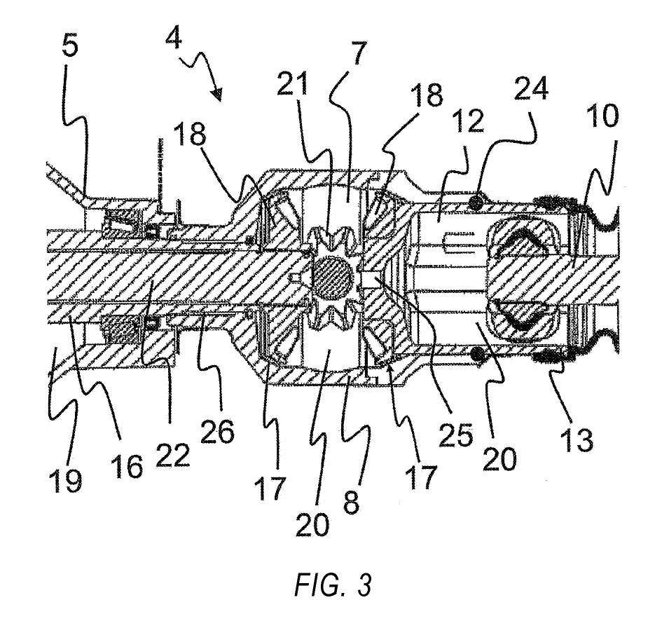

FIG. 3 shows a cross section through a differential 7, likewise configured as a bevel gear differential in the present exemplary embodiment, having the integrated first joint 12 as a constituent part of the sideshaft assembly 4, and also shows the two planetary gears 21 which lie opposite one another and are connected to the differential housing 8 and the bevel gears 18 which are arranged opposite one another and are in engagement with the planetary gears 21. The torques of the transmission 2 are transmitted from the hollow shaft 16 via the differential housing 8 and the planetary gears 21 to the bevel gears 18 and then firstly via the first joint outer body 13 to the first sideshaft 10 and secondly via the coupler shaft 22 and the second joint outer body 15 to the second sideshaft 11. The first joint outer body 13 is received rotatably here in the differential housing 8 which can be of single part or else multiple part configuration. In particular, the first joint 12 and the differential 7 can have separate lubricating systems, it also being possible to produce a common second lubricating system 20 via apertures 25 between the joint outer body 13 and the differential 7, the second lubricating system 20 being independent of the first lubricating system 19 of the transmission 4.

In particular, the second lubricating system 20 is then delimited by the differential housing 8 and the first joint outer body 13. The first lubricating system 19 is delimited via the transmission housing 5. The second lubricating system 20 is sealed with respect to the surroundings by suitable sealing elements 24.

In the case of plug-in connections 26 and/or journal connections firstly between the hollow shaft 16 and the differential housing 8 and secondly between the coupler shaft 22 and the second joint outer body 15, what is known as “humming” should be avoided, in particular, by corresponding mounting of the coupler shaft 22 in the hollow shaft 16 and of the hollow shaft 16 in the transmission housing 5.

In the exemplary embodiment which is shown here, the supporting faces 17 are arranged on the inner side of the differential housing 8, with the result that the bevel gears 18 can be supported on said inner face by way of their beveled circumferential face. The bevel gears 18 are therefore mounted radially in the differential housing 8 and are fixed axially at the same time by the supporting face 17 and the planetary gears 21. With a corresponding design, the supporting faces 17 can generate an additional frictional moment, with the result that the differential 7 is also suitable for use as a locking differential.

The present invention is not restricted to the exemplary embodiments which are shown. More specifically, an arrangement of the present disclosure is set forth according to the features of patent claim 1 and a joint outer body of claim 9. Advantageous refinements of the disclosure are specified in the dependent patent claims. Reference is made to the fact that the features which are described individually in the dependent patent claims can be combined with one another in any desired, technologically appropriate manner and define further refinements of the disclosure. Rather, a large number of modifications of the disclosure are possible within the scope of the patent claims. This relates, in particular, to the design of the joints as plunge joints or fixed joints of any known type.

What is claimed:

1. An arrangement for transmitting a torque from a transmission of a motor vehicle to a sideshaft, comprising:
at least one transmission having at least one transmission housing,
at least one sideshaft assembly having at least one differential with a differential housing, a hollow shaft, a first sideshaft and a second sideshaft,
wherein the sideshaft assembly extends partially through the transmission housing and the differential is arranged outside the transmission housing.

2. The arrangement as claimed in claim 1, wherein the first sideshaft has a first joint with a first joint outer body and the second sideshaft has a second joint with a second joint outer body, wherein and the first sideshaft is connected to the differential via the first joint and the second sideshaft is connected to the differential via the second joint.

3. The arrangement as claimed in claim 2, wherein the first joint outer body is integrated at least partially into the differential.

4. The arrangement as claimed in claim 1, wherein the differential housing is in engagement with the hollow shaft, and the hollow shaft transmits a torque of the transmission via a drive means of the hollow shaft and via an output means of the transmission.

5. The arrangement as claimed in claim 4, wherein the drive means of the hollow shaft is a main drive gearwheel and the output means of the transmission is an output gearwheel, and the main drive gearwheel is in engagement with the output gearwheel.

6. The arrangement as claimed in claim 2, wherein the differential housing has at least one supporting face for at least one bevel gear which is connected to the first joint outer body or second joint outer body.

7. The arrangement as claimed in claim 1, the transmission having a first lubricating system and the differential having a second lubricating system, the first lubricating system and the second lubricating system being configured independently of one another.

8. The arrangement as claimed in claim 7, wherein the differential and at least the first joint forms a common second lubricating system.

9. A joint outer body of a joint for use in an arrangement as claimed in claim 1, the joint outer body having a bevel gear.

10. The joint outer body as claimed in claim 9, the bevel gear being connected releasably to the joint outer body.
